(19) United States
(12) Patent Application Publication
(10) Pub. No.: US 2015/0351167 A1
(43) Pub. Date: Dec. 3, 2015

(54) ENCAPSULATED DEVICE HAVING EDGE SEAL AND METHODS OF MAKING THE SAME

(71) Applicant: Samsung SDI Co., Ltd., Yongin-si (KR)

(72) Inventors: Lorenza Moro, Palo Alto, CA (US); Damien S. Boesch, San Jose, CA (US); Xianghui Zeng, Albany, CA (US)

(21) Appl. No.: 14/723,402

(22) Filed: May 27, 2015

Related U.S. Application Data
(60) Provisional application No. 62/006,016, filed on May 30, 2014.

(51) Int. Cl. H05B 33/04; H05B 33/10

(52) U.S. Cl. CPC H05B 33/04; H05B 33/10

(57) ABSTRACT

An encapsulated device includes a barrier laminate on the device, and adhesive between the barrier laminate and the device, and an edge sealing member at an edge of the encapsulated device. The edge sealing member may be embedded in the adhesive, may enclose the adhesive between the barrier laminate and the device, or may cover an edge portion of the barrier laminate and an edge portion of the adhesive. A method of making an encapsulated device includes forming an edge sealing member by attaching it to an edge of the device, depositing it adjacent the edge of the device, or covering an edge of an encapsulated volume defined by the edge of the device with the edge sealing member. The method further includes applying an adhesive on the device, and applying a barrier laminate on the adhesive.

### CROSS-REFERENCE TO RELATED APPLICATION(S)

This application claims priority to and the benefit of U.S. Provisional Application No. 62/006,016, filed on May 30, 2014 and titled METHOD OF CREATING A NARROW EDGE SEAL IN A FLEXIBLE DISPLAY, the entire content of which is incorporated herein by reference.

### BACKGROUND

Many devices, such as organic light emitting devices and the like, are susceptible to degradation from the permeation of certain liquids and gases, such as water vapor and oxygen present in the environment, and other chemicals that may be used during the manufacture, handling or storage of the product. To reduce permeability to these damaging liquids, gases and chemicals, the devices are typically coated with a barrier coating or are encapsulated by incorporating a barrier stack adjacent one or both sides of the device.

Barrier coatings typically include a single layer of inorganic material, such as aluminum, silicon or aluminum oxides, or silicon nitrides. However, for many devices, such a single layer barrier coating does not sufficiently reduce or prevent oxygen or water vapor permeability. Indeed, in organic light emitting devices, for example, which require exceedingly low oxygen and water vapor transmission rates, these single layer barrier coatings do not adequately reduce or prevent the permeability of damaging gases, liquids and chemicals. Accordingly, in those devices (e.g., organic light emitting devices and the like), barrier stacks have been used in an effort to further reduce or prevent the permeation of damaging gases, liquids and chemicals.

In general, a barrier stack includes multiple dyads, each dyad being a two-layered structure including a bather layer and a decoupling layer. The barrier stack can be deposited directly on the device to be protected, or may be deposited on a separate film or support, and then laminated onto the device. When the barrier stack is deposited on a separate film and then laminated on the device, the edges around the device can remain exposed to air, and therefore susceptible to the ingress of, e.g., water vapor and oxygen. Accordingly, treatments for these edges are important in order to prevent the ingress of such damaging species.

Conventionally, edge seal has been accomplished through adhesives or getters. For example, edge seal may be accomplished by applying an adhesive either at the edges only or as a full face adhesive. However, these adhesives typically have water vapor transmission rates that are not compatible with the required lifetime of a sensitive device, such as an organic light-emitting device (OLED). Additionally, these adhesives are generally not flexible. Pressure-sensitive adhesive sealants have also been used, but these adhesives are thick (e.g., 25 microns), and do not provide a satisfactory bather to edge permeation.

Glass frit and laser sealing methods have also been used in glass-to-glass devices, but these techniques are not compatible with flexible plastic substrates. Additionally, when these techniques are used with flexible glass substrates, the mechanical stress at the edges leads to fragmenting of the entire glass substrate.

Edge seal has also been accomplished through the use of thermoplastic desiccant tapes and getters placed inside the encapsulated volume (i.e., the volume between the bather film, the device being encapsulated, and the underlying substrate on which the device is positioned). However, desiccant tapes require curing at high temperatures, and are generally not flexible after cure. Additionally, while getters may capture water and oxygen permeating through the adhesive in the encapsulated volume, the resulting high load leads to losses in transparency.

### SUMMARY

According to embodiments of the present invention, an encapsulated device includes a barrier laminate on the device, an adhesive between the barrier laminate and the device, and an edge sealing member for sealing the edges of the encapsulated device. The barrier laminate includes one or more dyads, and each dyad includes a barrier layer including a barrier material and a decoupling layer including a polymeric or organic material. The edge sealing member may be embedded in the adhesive or may cover an edge portion of the barrier laminate and an edge portion of the adhesive. The edge sealing member comprises a metal material, e.g., a flexible metal material.

In some embodiments, the edge sealing member may include a metal ribbon that covers the edge portion of the barrier laminate and the edge portion of the adhesive. For example, in some embodiments, the barrier laminate and the device define an encapsulated volume having an edge thickness between the barrier laminate and the device, and the metal ribbon covers the edge thickness of the encapsulated volume.

According to some embodiments, the edge sealing member may include a metal strut that extends from the device and is embedded in the adhesive. For example, in some embodiments, the barrier laminate and the device define an encapsulated volume having an edge thickness between the barrier laminate and the device, and the metal strut extends from the device into the adhesive and has a thickness that is smaller than the edge thickness of the encapsulated volume. Additionally, the metal strut may have a thickness that is smaller than a thickness of the device.

In some embodiments, the edge sealing member may include a metal ink printed adjacent the device and embedded in the adhesive. For example, in some embodiments, the barrier laminate and the device define an encapsulated volume having an edge thickness between the barrier laminate and the device, and the metal ink is printed spaced from but adjacent the device (e.g., on an underlying substrate on which the device is positioned) and to a thickness that may be either generally equal to or smaller than the edge thickness of the encapsulated volume. Additionally, the metal ink may have a thickness that is generally equal to or smaller than a thickness of the device.

The metal material of the edge sealing member may include any suitable material, e.g., a metal or metal oxide. For example, in some embodiments, the metal or metal oxide material may include a metal selected from Group 13 metals (e.g., Al and/or In), Group 14 metals (e.g., Sn and Pb), transition metals (e.g., Cu and/or Ti), alkali metals, alkaline earth metals, and alloys and oxides thereof. In some embodiments, for example, the metal material of the edge sealing member may include a metal selected from aluminum, copper, indium, titanium, barium, magnesium, calcium, sodium, strontium, cesium, zirconium, vanadium, cobalt, iron, and alloys or oxides thereof.

The barrier material of the barrier layer may be any material suitable for effective prevention of gas permeation. For example, in some embodiments, the barrier material may include a material selected from metals, metal oxides, metal nitrides, metal oxynitrides, metal carbides, metal oxyborides, Al, Zr, Zn, Sn, Ti, and combinations thereof.

According to some embodiments, a method of making an encapsulated device includes depositing an edge sealing member to an edge of the device or adjacent the edge of the device. The edge sealing member includes a metal material. The method further includes applying an adhesive on the device and the edge sealing member, and applying a barrier laminate on the adhesive. The barrier laminate includes one or more dyads, and each dyad includes a barrier layer and a decoupling layer. The barrier layer of the dyad includes a barrier material, and the decoupling layer includes a polymeric or organic material.

Depositing the edge sealing member may include attaching a metal strut to the edge of the device, or depositing a metal ink adjacent the edge of the device. Additionally, applying the barrier laminate on the adhesive creates an encapsulated volume having an edge thickness, and the metal ink or metal strut may have a thickness smaller than the edge thickness of the encapsulated volume. Alternatively, the metal ink may have a thickness that is generally equal to the edge thickness of the encapsulated volume. Also the thickness of the metal ink or the metal strut may be generally equal to or smaller than a thickness of the device being encapsulated.

The metal material of the edge sealing member may include any suitable material, e.g., a metal or metal oxide material. For example, in some embodiments, the metal or metal oxide material may include a metal selected from Group 13 metals (e.g., Al and/or In), Group 14 metals (e.g., Sn and Pb), transition metals (e.g., Cu and/or Ti), alkali metals, alkaline earth metals, and alloys and oxides thereof. In some embodiments, for example, the metal material of the edge sealing member may include a metal selected from aluminum, copper, indium, titanium, barium, magnesium, calcium, sodium, strontium, cesium, zirconium, vanadium, cobalt, iron, and alloys or oxides thereof.

In some embodiments, a method of making an encapsulated device includes applying an adhesive on the device, applying a barrier laminate on the adhesive, and applying an edge sealing member covering an edge portion of the barrier laminate and an edge portion of the adhesive. The barrier laminate includes one or more dyads, and each dyad includes a barrier layer comprising a barrier material and a decoupling layer comprising a polymeric or organic material. The edge sealing member includes a metal material.

Depositing the edge sealing member may include attaching a metal ribbon to the edge portion of the barrier laminate and the edge portion of the adhesive. For example, applying the barrier laminate on the adhesive creates an encapsulated volume having an edge thickness, and the metal ribbon may cover the edge thickness of the encapsulated volume.

The metal material of the edge sealing member may include any suitable metal material. In some embodiments, for example, the metal material of the edge sealing member includes a metal selected from aluminum, copper, indium, titanium, barium, magnesium, calcium, sodium, strontium, cesium, zirconium, vanadium, cobalt, iron, and alloys thereof.

### BRIEF DESCRIPTION OF THE DRAWINGS

These and other features and advantages of the present invention will be better understood by reference to the following detailed description when considered in conjunction with the following drawings, in which:

FIG. 1A is a schematic plan view of a device deposited on an base substrate prior to encapsulation with a barrier film (or laminate), showing the edge width that will result when the device is encapsulated with the barrier film;

FIG. 1B is a schematic perspective view of an encapsulated device prior to application of an edge seal, showing the edge thickness of the encapsulated device;

FIG. 2 is a schematic cross-sectional view of an encapsulated device according to embodiments of the present invention;

FIG. 3 is a schematic cross-sectional view of another encapsulated device according to embodiments of the present invention; and

FIG. 4 is a schematic cross-sectional view of yet another encapsulated device according to embodiments of the present invention;

FIG. 5 is a schematic cross-sectional view of a barrier film (or laminate) according to embodiments of the present invention; and

FIG. 6 is a schematic cross-sectional view of another barrier film (or laminate) according to embodiments of the present invention.

### DETAILED DESCRIPTION

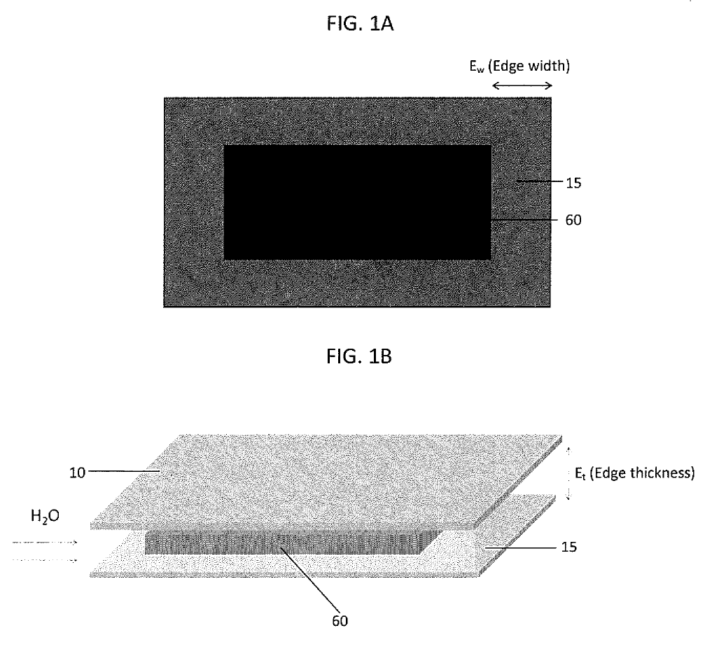

According to embodiments of the present invention, an encapsulated device includes a barrier laminate on the device, an adhesive and an edge sealing member. The barrier laminate protects the underlying device from the permeation of damaging gasses, such as water vapor and oxygen, but some permeation may still occur at the edges of the encapsulated device. In particular, as shown in FIG. 1A, prior to encapsulation, a device 60 may be positioned on a base substrate 15, which creates edges E around the device 15. As shown in FIG. 1B, upon application of the barrier film 10 on the device 60, an encapsulated volume is created between the edge of the device 60 and the edges of the base substrate 15 and the barrier film 10. This encapsulated volume has an edge thickness Eₜ defined by the space (or thickness) between the base substrate 15 and the barrier film 10 that is created due to the device 60 positioned between the base substrate 15 and the barrier film 10. Additionally, the encapsulated volume has an edge width E_{w} defined by the space (or width) between the edge of the device 60 and the edges of the base substrate 15 and the barrier film 10. As can be seen in FIG. 1B, the edges of the encapsulated volume are susceptible to the permeation of damaging species, such as, e.g., water and oxygen. While the application of certain adhesives at the edges of the encapsulated volume can sometimes reduce the amount of permeation to the encapsulated device, existing adhesive technology does not provide a low enough transmission rate to prolong the lifetime of the most sensitive of devices, e.g., organic light-emitting devices (OLEDs).

Additionally, modern OLEDs demand large viewing screens while maintaining the smallest possible total display. Accordingly, the edges of the encapsulated volume must be made as small as possible (i.e., have minimized edge widths E_{w}) in order to make the end display as close as possible in size to the size of the viewing screen. However, larger edge widths E_{w} mean that damaging gasses have further to travel before reaching the sensitive OLED. As such, minimizing the edge width provides a shorter path for the damaging gasses to travel before reaching, and thereby damaging the encapsulated OLED.

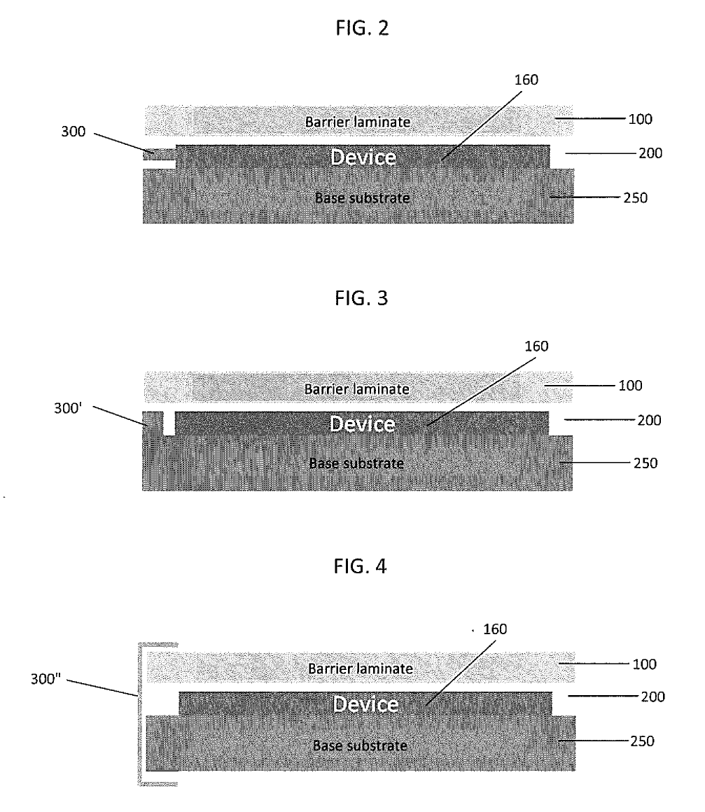

According to embodiments of the present invention, an encapsulated device is protected against the permeation of these damaging gasses even with minimized edge widths. In some embodiments of the present invention, as noted above, an encapsulated device includes a barrier laminate on the device, an adhesive and an edge sealing member. The edge sealing member may be embedded in the adhesive (as shown in FIGS. 2 and 3) or may cover an edge portion of the barrier laminate and an edge portion of the adhesive (as shown in FIG. 4). The edge sealing member comprises an edge sealing material, e.g., a metal material. In some embodiments, e.g., the edge sealing material includes a flexible metal material.

In some embodiments, for example, as shown in FIG. 2, the edge sealing member may include an edge strip or strut 300 of edge sealing material that is attached to the edges of the device 60 being encapsulated. For example, the edge strip (or strut) 300 may be attached around the active areas of the device 60. The edge strip (or strut) 300 may extend from the device 60 along the edge width of the encapsulated volume, and may be embedded in the adhesive 200. As shown in FIG. 2, the edge strip (or strut) 300 may have a thickness that is smaller than a thickness of the device 60. However, the edge strip is not limited to such a thickness, and in some embodiments, the edge strip (or strut) 300 may have a thickness that is generally equal to the thickness of the device. As used herein, the term “generally” is used as a term of approximation and not as a term of degree, and is intended to account for inherent and standard deviations in the estimation of the equal thickness of the edge strip (or strut) and the device. In some embodiments, the edge strip (or strut) 300 may be thicker than the device.

The edge strip (or strut) 300 serves to reduce the edge thickness Eₜ of the encapsulated volume, which thereby reduces the ingress area for the permeation of gasses. In particular, the edge strip (or strut) 300 reduces the area through which gasses can permeate at the edges of the encapsulated device by a factor of (Eₜ−Tₑₛ/Eₜ), where Eₜ is the edge thickness of the encapsulated volume (described above), and Tₑₛ is the thickness of the edge strip (or strut). In some embodiments, the edge strip (or strut) 300 comprises a metal strip (or strut) attached to the edges of the device 60.

In some embodiments, for example, as shown in FIG. 3, the edge sealing member may include an edge sealing ink 300′ (also referred to herein as simply as “edge ink”) deposited (e.g., printed) adjacent the device 60. For example, as shown in FIG. 3, the edge sealing ink 300′ may be deposited at an edge of the encapsulated volume, and may be spaced from but adjacent to the device on an underlying base substrate 250. The edge sealing ink 300′ may extend from the base substrate along the edge thickness Eₜ, and be embedded (at least partially) in the adhesive 200. As shown in FIG. 3, the edge sealing ink 300′ may have a thickness that is generally equal to the thickness of the device 60. As used herein, the term “generally” is used as a term of approximation and not as a term of degree, and is intended to account for inherent and standard deviations in the estimation of the equal thickness of the edge sealing ink and the device. Indeed, the edge sealing ink 300′ may completely seal the edges of the encapsulated volume, creating areas at the edges of the encapsulated volume that include no adhesive, thereby enclosing the adhesive between the device and the barrier laminate. The edge sealing ink 300′ is not limited to such a thickness, and in some embodiments, the edge sealing ink 300′ may have a thickness that is smaller than or larger than the thickness of the device. Additionally, the edge sealing ink 300′ may have a thickness that is generally equal to, or smaller than the edge thickness Eₜ of the encapsulated volume. In some embodiments, the edge sealing ink 300′ may comprise a metal ink printed on the base substrate adjacent the device.

The edge sealing ink 300′ serves as a dam against the ingress of damaging gasses and species to the device 60. In particular, the edge sealing ink 300′ is located at the edge of the encapsulated volume and presents a barrier against the permeation of gasses at the edges, thereby blocking ingress of the gasses through the edge width E_{w} toward the device 60. Additionally, in those embodiments in which the edge sealing ink 300′ has a thickness smaller than the edge thickness of the encapsulated volume, the edge sealing ink 300′ (embedded in the adhesive) reduces the edge thickness Eₜ of the encapsulated volume, which thereby reduces the ingress area for the permeation of gasses. In particular, like the edge sealing strip 300 discussed in connection with FIG. 2, the edge sealing ink 300′ reduces the area through which gasses can permeate at the edges of the encapsulated device by a factor of (Eₜ−Tₑᵢ/Eₜ), where Eₜ is the edge thickness of the encapsulated volume (described above), and Tₑᵢ is the thickness of the edge ink. In some embodiments, the edge sealing ink 300′ comprises a metal ink deposited (e.g., printed) on the base substrate 250 adjacent the device at the edges of the encapsulated volume. The edge ink 300′ may be deposited by any suitable printing or deposition technique, many of which are known to those of ordinary skill in the art.

In some embodiments, for example, as shown in FIG. 4, the edge sealing member may include an edge sealing ribbon 300″ (also referred to herein as simply as “edge ribbon”) covering the edge thickness Eₜ of the encapsulated volume. For example, as shown in FIG. 4, the edge sealing ribbon 300″ may be applied over the outer surfaces of the entire edge thickness, as well as over the edge thickness of the base substrate 250 and the barrier laminate 100. In some embodiments, as shown in FIG. 4, the edge ribbon 300″ may also include overlapping regions that extend beyond the thickness of the encapsulated device (i.e., the combined edge thickness of the encapsulated volume, base substrate and barrier laminate). The overlapping portions may be folded over on top of the barrier film 100 and beneath the base substrate 250, as shown in FIG. 4. The edge sealing ribbon 300″ may have any suitable thickness, but as the edge ribbon 300″ encloses the edge of the encapsulated device, it is not necessary that the edge ribbon 300″ have a thickness bearing any particular relationship to the device or the edge thickness of the encapsulated volume. Instead, the edge ribbon 300″ has a width sufficient to cover the entire edge thickness of the encapsulated volume. In some embodiments, for example, as shown in FIG. 4, the width of the edge ribbon 300″ is greater than the edge thickness of the encapsulated volume so as to ensure coverage of the edge thickness by the edge ribbon 300″. However, the width of the edge ribbon 300″ is not particularly limited, and may be smaller than, generally equal to, or larger than the edge thickness of the encapsulated volume. As used herein, the term “generally” is used as a term of approximation and not as a term of degree, and is intended to account for inherent and standard deviations in the estimation of the equality of the edge thickness to the ribbon width. In some embodiments, the edge sealing ribbon 300″ may comprise a metal ribbon attached to the edge of the encapsulated device.

The edge ribbon 300″ serves to increase the effective edge width of the encapsulated device. In particular, the edge sealing ribbon 300″ is framed around the edges of the encapsulated device, creating an edge sealing frame which increases the thickness at the edges of the encapsulated device. Indeed, the thickness of the edge sealing ribbon 300″ is not particularly limited. For example, the edge sealing ribbon 300″ may have a thickness that is even greater than a combined thickness of the encapsulated device (i.e., the combined thickness of the encapsulated volume, the base substrate and the barrier laminate). As one non-limiting example, it is possible for the total combined thickness of the encapsulated device (i.e., the combined thickness of the encapsulated volume, the base substrate and the barrier laminate) to be on the order of 200 microns or smaller, while the edge ribbon may have a thickness of 500 microns or greater. In some embodiments, the edge sealing ribbon 300″ comprises a metal ribbon applied on the edges of the encapsulated device. The edge ribbon 300″ may be applied on the edges of the encapsulated device by any suitable method, for example, using an adhesive.

The edge sealing material of the edge sealing member (including the above described edge sealing strip (or strut) 300, edge sealing ink 300′, and edge sealing ribbon 300″) is not particularly limited so long as the material is capable of preventing or reducing permeation of gasses to the device. For example, the edge sealing material may be a material that is not reactive with the damaging gasses (e.g., water vapor and oxygen), but is also not permeable to the gasses, and therefore acts as barrier against the ingress of those gasses to the device. In some embodiments, however, the edge sealing material may include a material that is partially reactive with the damaging gasses (e.g., water vapor and oxygen) via oxidation, thereby acting as getters, absorbing the gasses before they reach the device. In some embodiments, for example, the edge sealing material may include any suitable material, e.g., a metal material or metal oxide material. For example, in some embodiments, the metal or metal oxide material may include a metal selected from Group 13 metals (e.g., Al and/or In), Group 14 metals (e.g., Sn and Pb), transition metals (e.g., Cu and/or Ti), alkali metals, alkaline earth metals, and alloys and oxides thereof. In some embodiments, for example, the metal material of the edge sealing member may include a metal selected from aluminum, copper, indium, titanium, barium, magnesium, calcium, sodium, strontium, cesium, zirconium, vanadium, cobalt, iron, and alloys or oxides thereof.

In some embodiments, the edge sealing material includes a flexible metal material, such as a metal foil. The use of such a flexible material as the edge sealing member enables the encapsulated device to maintain flexibility while also decreasing permeation of gasses through the edges.

The adhesive may be any adhesive suitable for use with sensitive devices, such as organic light emitting devices, and which enables adhesion of the barrier laminate to the device. In some embodiments, for example, the adhesive may include a curable adhesive, or a pressure-sensitive adhesive. Adhesives for this purpose are known in the art, and those of ordinary skill in the art would be capable of selecting an appropriate adhesive for lamination of the barrier laminate to the device.

The barrier laminate includes one or more dyads, each of which includes a first layer that acts as a smoothing or planarization layer, and a second layer that acts as a barrier layer. The layers of the barrier laminate are deposited on a separate substrate or support, and then laminated on the device. The first layer of the dyad includes a polymer or other organic material that serves as a planarization, decoupling and/or smoothing layer. Specifically, the first layer decreases surface roughness, and encapsulates surface defects, such as pits, scratches, digs and particles, thereby creating a planarized surface that is ideal for the subsequent deposition of additional layers. As used herein, the terms “first layer,” “smoothing layer,” “decoupling layer,” and “planarization layer” are used interchangeably, and all terms refer to the first layer, as now defined. The first layer may be deposited on the substrate by any suitable deposition technique, some nonlimiting examples of which include vacuum processes and atmospheric processes. Some nonlimiting examples of suitable vacuum processes for deposition of the first layer include flash evaporation with in situ polymerization under vacuum, and plasma deposition and polymerization. Some nonlimiting examples of suitable atmospheric processes for deposition of the first layer include spin coating, ink jet printing, screen printing and spraying.

The first layer can include any suitable material capable of acting as a planarization, decoupling and/or smoothing layer. Some nonlimiting examples of suitable such materials include organic polymers, inorganic polymers, organometallic polymers, hybrid organic/inorganic polymer systems, and silicates. In some embodiments, for example, the material of the first layer may be an acrylate-containing polymer, an alkylacrylate-containing polymer (including but not limited to methacrylate-containing polymers), or a silicon-based polymer.

The first layer can have any suitable thickness such that the layer has a substantially planar and/or smooth layer surface. As used herein, the term “substantially” is used as a term of approximation and not as a term of degree, and is intended to account for normal variations and deviations in the measurement or assessment of the planar or smooth characteristic of the first layer. In some embodiments, for example, the first layer has a thickness of about 100 to 1000 nm.

The second layer of the dyad is the layer that operates as the barrier layer, preventing the permeation of damaging gases, liquids and chemicals to the encapsulated device. Indeed, as used herein, the terms “second layer” and “barrier layer” are used interchangeably. The second layer is deposited on the first layer, and deposition of the second layer may vary depending on the material used for the second layer. However, in general, any deposition technique and any deposition conditions can be used to deposit the second layer. For example, the second layer may be deposited using a vacuum process, such as sputtering, chemical vapor deposition, metalorganic chemical vapor deposition, plasma enhanced chemical vapor deposition, evaporation, sublimation, electron cyclotron resonance-plasma enhanced chemical vapor deposition, and combinations thereof.

In some embodiments, however, the second layer is deposited by AC or DC sputtering. For example, in some embodiments, the second layer is deposited by AC sputtering. The AC sputtering deposition technique offers the advantages of faster deposition, better layer properties, process stability, control, fewer particles and fewer arcs. The conditions of the AC sputtering deposition are not particularly limited, and as would be understood by those of ordinary skill in the art, the conditions will vary depending on the area of the target and the distance between the target and the substrate. In some exemplary embodiments, however, the AC sputtering conditions may include a power of about 3 to about 6 kW, for example about 4 kW, a pressure of about 2 to about 6 mTorr, for example about 4.4 mTorr, an Ar flow rate of about 80 to about 120 sccm, for example about 100 sccm, a target voltage of about 350 to about 550 V, for example about 480V, and a track speed of about 90 to about 200 cm·min, for example about 141 cm/min. Also, although the inert gas used in the AC sputtering process can be any suitable inert gas (such as helium, xenon, krypton, etc.), in some embodiments, the inert gas is argon (Ar).

The material of the second layer is not particularly limited, and may be any material suitable for substantially preventing or reducing the permeation of damaging gases, liquids and chemicals (e.g., oxygen and water vapor) to the encapsulated device. Some nonlimiting examples of suitable materials for the second layer include metals, metal oxides, metal nitrides, metal oxynitrides, metal carbides, metal oxyborides, and combinations thereof. Those of ordinary skill in the art would be capable of selecting a suitable metal for use in the oxides, nitrides and oxynitrides based on the desired properties of the layer. However, in some embodiments, for example, the metal may be Al, Zr, Si, Zn, Sn or Ti.

The density and refractive index of the second layer is not particularly limited and will vary depending on the material of the layer. However, in some exemplary embodiments, the second layer may have a refractive index of about 1.6 or greater, e.g., 1.675. The thickness of the second layer is also not particularly limited. However, in some exemplary embodiments, the thickness is about 20 nm to about 100 nm, for example about 40 nm to about 70 nm. In some embodiments, for example, the thickness of the third layer is about 40 nm. As is known to those of ordinary skill in the art, thickness is dependent on density, and density is related to refractive index. See, e.g., Smith, et al., “Void formation during film growth: A molecular dynamics simulation study,” J. Appl. Phys., 79 (3), pgs. 1448-1457 (1996); Fabes, et al., “Porosity and composition effects in sol-gel derived interference filters,” Thin Solid Films, 254 (1995), pgs. 175-180; Jerman, et al., “Refractive index of this films of SiO₂, ZrO₂, and HfO₂ as a function of the films' mass density,” Applied Optics, vol. 44, no. 15, pgs. 3006-3012 (2005); Mergel, et al., “Density and refractive index of TiO₂ films prepared by reactive evaporation,” Thin Solid Films, 3171 (2000) 218-224; and Mergel, D., “Modeling TiO₂ films of various densities as an effective optical medium,” Thin Solid Films, 397 (2001) 216-222, all of which are incorporated herein by reference. Also, the correlation between film density and barrier properties is described, e.g., in Yamada, et al., “The Properties of a New Transparent and Colorless Barrier Film,” Society of Vacuum Coaters, 505/856-7188, 38^{th} Annual Technical Conference Proceedings (1995) ISSN 0737-5921, the entire content of which is also incorporated herein by reference. Accordingly, those of ordinary skill in the art would be able to calculate the density of the second layer based on the refractive index and/or thickness information.

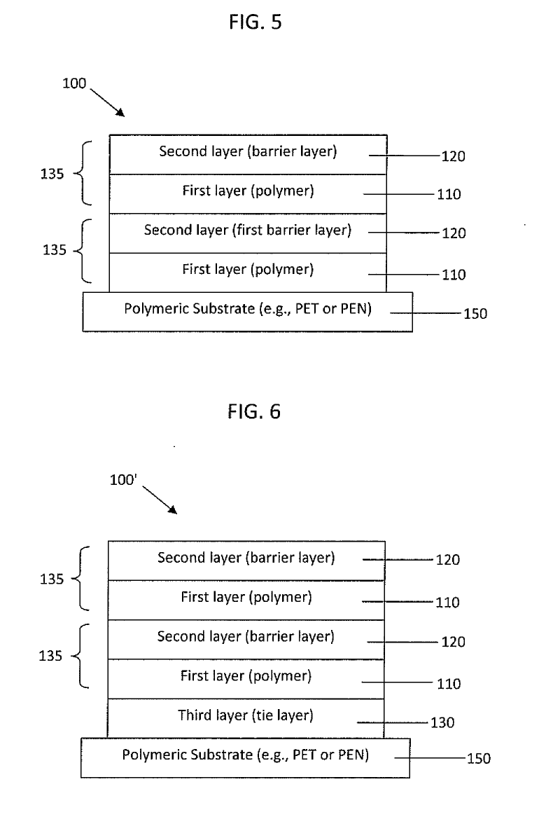

Exemplary embodiments of a barrier laminate are illustrated in FIGS. 5 and 6. The barrier laminate 100 depicted in FIG. 5 includes two dyads 135, each of which includes a first layer 110 which includes a decoupling layer or smoothing layer (i.e., the first layer discussed above), and a second layer 120 which includes a barrier layer (i.e., the second layer discussed above). The dyads 135 are deposited on a substrate 150 to complete the barrier laminate 100. The substrate 150 may be any common substrate, nonlimiting examples of which may include polyethylene terephthalate (PET), polyethylene naphthalate (PEN), polycarbonate, polyimide, and polyetherether ketone (PEEK).

In addition to the first and second layers 110 and 120, respectively, making up a dyad 135, in some exemplary embodiments, the barrier laminate 100′ can include a third layer 130 between the first layer 110 and the substrate 150, as shown in FIG. 6. Although the barrier laminates are discussed herein and depicted in the accompanying drawings as including first and second layers 110 and 120, respectively, of a dyad 135, and a third layer 130, it is understood that these layers may be deposited on the substrate 150 in any order, and the identification of the first, second and third layers as first, second, and third, respectively, does not mean that these layers must be deposited in that order. Indeed, as discussed here, and depicted in FIG. 6, in some embodiments, the third layer 140 is deposited on the substrate 150 prior to deposition of the first layer 110.

The third layer 130 acts as a tie layer, improving adhesion between the layers of the dyads 135 and the substrate 150. The material of the third layer 130 is not particularly limited, and can include the materials described above with respect to the second layer. Also, the material of the third layer may be the same as or different from the material of the second layer. The materials of the second layer are described in detail above.

Additionally, the third layer may be deposited on the substrate by any suitable technique, including, but not limited to the techniques described above with respect to the second layer. In some embodiments, for example, the third layer may be deposited by AC or DC sputtering under conditions similar to those described above for the second layer. Also, the thickness of the deposited third layer is not particularly limited, and can be any thickness suitable to effect good adhesion between the layers of the dyads 135 and the substrate. In some embodiments, for example, the third (tie) layer can have a thickness of about 20 nm to about 60 nm, for example, about 40 nm.

An exemplary embodiment of a barrier laminate 100′ including a third layer 130 is depicted in FIG. 6. The barrier laminate 100′ depicted in FIG. 6 includes a first layer 110 which includes a decoupling layer, a third layer 130 which includes an oxide tie layer, and a second layer 120 which includes a barrier layer. In FIG. 6, the dyads 135 are deposited on the substrate 150, which can be any common substrate, nonlimiting examples of which may include PET, PEN, polycarbonate, polyimide, and polyetherether ketone (PEEK).

In some embodiments of the present invention, a method of making an encapsulated device includes forming an edge sealing member by attaching the edge sealing member to an edge of the device, depositing the edge sealing member adjacent the edge of the device, or covering an edge of an encapsulated volume defined by the edge of the device with the edge sealing member. The method further includes applying an adhesive on the device, and applying a barrier laminate on the adhesive. The barrier laminate includes one or more dyads, each of which includes a barrier layer and a decoupling layer.

The edge sealing member is as described above in connection with the encapsulated devices. For example, depositing the edge sealing member may include attaching an edge strut (or strip) to the edge of the device, depositing an edge ink adjacent the edge of the device, or applying an edge ribbon covering the edge of the encapsulated volume defined by the device and the barrier laminate.

As discussed above, the edge sealing material of the edge sealing member may include any suitable material, e.g., a metal or metal oxide material. For example, in some embodiments, the metal or metal oxide material may include a metal selected from Group 13 metals (e.g., Al and/or In), Group 14 metals (e.g., Sn and Pb), transition metals (e.g., Cu and/or Ti), alkali metals, alkaline earth metals, and alloys and oxides thereof. In some embodiments, for example, the metal material of the edge sealing member may include a metal selected from aluminum, copper, indium, titanium, barium, magnesium, calcium, sodium, strontium, cesium, zirconium, vanadium, cobalt, iron, and alloys or oxides thereof.

The barrier laminate is as discussed above in connection with the encapsulated devices. The method may further include forming the barrier laminate prior to application of the barrier laminate on the device. Forming the barrier laminate includes forming a first layer 110 on the substrate. The first layer 110 is as described above and acts as a decoupling, smoothing and/or planarization layer. As also discussed above, the first layer 110 may be deposited on the device 160 or substrate 150 by any suitable deposition technique, including, but not limited to, vacuum processes and atmospheric processes. Some nonlimiting examples of suitable vacuum processes for deposition of the first layer include flash evaporation with in situ polymerization under vacuum, and plasma deposition and polymerization. Some nonlimiting examples of suitable atmospheric processes for deposition of the first layer include spin coating, ink jet printing, screen printing and spraying.

Forming the barrier laminate further includes depositing a second layer 120 on the surface of the first layer 110. The second layer 120 is as described above and acts as the barrier layer of the barrier stack, serving to substantially prevent or substantially reduce the permeation of damaging gases, liquids and chemicals to the underlying device. The deposition of the second layer 120 may vary depending on the material used for the second layer. However, in general, any deposition technique and any deposition conditions can be used to deposit the second layer. For example, the second layer 120 may be deposited using a vacuum process, such as sputtering, chemical vapor deposition, metalorganic chemical vapor deposition, plasma enhanced chemical vapor deposition, evaporation, sublimation, electron cyclotron resonance-plasma enhanced chemical vapor deposition, and combinations thereof. In some embodiments, however, the second layer 120 is deposited by AC or DC sputtering, for example pulsed AC or pulsed DC sputtering. While any suitable conditions for deposition can be employed, some suitable conditions are described above.

In some embodiments, forming the barrier laminate may further include repeating deposition of the first layer 110 and second layer 120 to form multiple dyads 135 on the substrate.

In some embodiments, forming the barrier laminate may further include depositing a third layer 130 between the substrate 150 and the first layer 110. The third layer 130 is as described above and acts as a tie layer for improving adhesion between the substrate and the first layer 110 of a dyad 135. The third layer 130 may be deposited by any suitable technique, as discussed above. For example, as also discussed above, the third layer 130 may be deposited on the substrate 150 by AC or DC sputtering, e.g., pulsed AC or pulsed DC sputtering. As also discussed above, the barrier material of the barrier layer may be selected from the group consisting of metals, metal oxides, metal nitrides, metal oxynitrides, metal carbides, metal oxyborides, Al, Zr, Zn, Sn, Ti, and combinations thereof.

In applying the barrier laminate on the adhesive, an encapsulated volume between the barrier laminate and the device is created. The encapsulated volume has an edge thickness. In some embodiments, the edge sealing member (e.g., the edge sealing ink or the edge sealing strut) has a thickness that is generally equal to, smaller than or greater than the edge thickness of the encapsulated volume. For example, in some embodiments, the edge sealing member has a thickness that is smaller than the edge thickness of the encapsulated volume.

According to some embodiments, a method of encapsulating a device includes applying an adhesive on the device, applying a barrier laminate on the adhesive, and applying an edge sealing member covering an edge portion of the barrier laminate and an edge portion of the adhesive. The barrier laminate is as described above, and the edge sealing member includes a metal material. The edge sealing member may be an edge ribbon with any suitable thickness, as also described above in connection with the encapsulated devices.

Depositing the edge sealing member may include attaching an edge ribbon (e.g., a metal ribbon) to the edge portion of the barrier laminate and the edge portion of the adhesive. As discussed above, the edge ribbon may have any suitable width, for example a width suitable to cover the edge thickness of the encapsulated volume defined by the barrier laminate and the device. In some embodiments, the edge ribbon may have a width suitable to cover the combined thickness of the base substrate, encapsulated volume and barrier laminate. Additionally, in some embodiments, the edge ribbon may have a width that is larger than the combined thickness of the base substrate, encapsulated volume and barrier laminate, and the overlapping potions of the edge ribbon may be attached on the top of the barrier film and the bottom of the base substrate, thereby creating a complete edge seal.

As discussed above, the edge sealing material of the edge sealing member may include any suitable material, e.g., a metal or metal oxide material. For example, in some embodiments, the metal or metal oxide material may include a metal selected from Group 13 metals (e.g., Al and/or In), Group 14 metals (e.g., Sn and Pb), transition metals (e.g., Cu and/or Ti), alkali metals, alkaline earth metals, and alloys and oxides thereof. In some embodiments, for example, the metal material of the edge sealing member may include a metal selected from aluminum, copper, indium, titanium, barium, magnesium, calcium, sodium, strontium, cesium, zirconium, vanadium, cobalt, iron, and alloys or oxides thereof.

As discussed above, according to embodiments of the present invention, an encapsulated device includes an adhesive on the device, a barrier laminate on the adhesive, and an edge sealing member at an edge of the encapsulated volume defined by the barrier laminate and the device. The edge sealing member prevents or reduces the amount of gasses that permeate through the edges of the encapsulated volume toward the device.

While certain exemplary embodiments of the present invention have been illustrated and described, it is understood by those of ordinary skill in the art that certain modifications and changes can be made to the described embodiments without departing from the spirit and scope of the present invention.

What is claimed is:

1. An encapsulated device, comprising:
a barrier laminate on the device, the barrier laminate comprising one or more dyads, each dyad comprising a barrier layer and a decoupling layer, the barrier layer comprising a barrier material, and the decoupling layer comprising a polymeric or organic material;
an adhesive between the barrier laminate and the device; and
an edge sealing member at an edge of the encapsulated device, the edge sealing member being embedded in the adhesive, enclosing the adhesive between the barrier laminate and the device, or covering an edge portion of the barrier laminate and an edge portion of the adhesive, the edge sealing member comprising a metal material.

2. The encapsulated device of claim 1, wherein the edge sealing member comprises a metal ribbon covering the edge portion of the barrier laminate and the edge portion of the adhesive, a metal strut extending from the device and embedded in the adhesive, or a metal ink adjacent the device and either being embedded in the adhesive or enclosing the adhesive between the barrier laminate and the device.

3. The encapsulated device of claim 1, wherein the metal material of the edge sealing member comprises a metal selected from the group consisting of Group 13 metals, Group 14 metals, transition metals, alkali metals, alkaline earth metals, alloys thereof and oxides thereof.

4. The encapsulated device of claim 1, wherein the metal material of the edge sealing member comprises a metal selected from the group consisting of aluminum, copper, indium, titanium, barium, magnesium, calcium, sodium, strontium, cesium, zirconium, vanadium, cobalt, iron, alloys thereof, and oxides thereof.

5. The encapsulated device according to claim 1, wherein the barrier material of the barrier layer is selected from the group consisting of metals, metal oxides, metal nitrides, metal oxynitrides, metal carbides, metal oxyborides, Al, Zr, Zn, Sn, Ti, and combinations thereof.

6. The encapsulated device of claim 2, wherein the barrier laminate and the device define an encapsulated volume between the barrier laminate and the device, the encapsulated volume comprising an edge thickness, and the metal ink having a thickness smaller than the edge thickness of the encapsulated volume.

7. The encapsulated device of claim 2, wherein the barrier laminate and the device define an encapsulated volume between the barrier laminate and the device, the encapsulated volume comprising an edge thickness, and the metal strut having a thickness smaller than the edge thickness of the encapsulated volume.

8. The encapsulated device of claim 2, wherein the barrier laminate and the device define an encapsulated volume between the barrier laminate and the device, the encapsulated volume comprising an edge thickness, the metal ribbon covering the edge thickness of the encapsulated volume.

9. A method of encapsulating a device, the method comprising:
forming an edge sealing member at an edge of the device or adjacent the edge of the device, the edge sealing member comprising a metal material;
applying an adhesive on the device; and
applying a barrier laminate on the adhesive, the barrier laminate comprising one or more dyads, each dyad comprising a barrier layer and a decoupling layer, the barrier layer comprising a barrier material, and the decoupling layer comprising a polymeric or organic material.

10. The method of claim 9, wherein the depositing the edge sealing member comprises attaching a metal strut to the edge of the device, or depositing a metal ink adjacent the edge of the device.

11. The method of claim 9, wherein the metal material of the edge sealing member comprises a metal selected from the group consisting of Group 13 metals, Group 14 metals, transition metals, alkali metals, alkaline earth metals, alloys thereof, and oxides thereof.

12. The method of claim 9, wherein the metal material of the edge sealing member comprises a metal selected from the group consisting of aluminum, copper, indium, titanium, barium, magnesium, calcium, sodium, strontium, cesium, zirconium, vanadium, cobalt, iron, alloys thereof, and oxides thereof.

13. The method according to claim 9, wherein the barrier material of the barrier layer is selected from the group consisting of metals, metal oxides, metal nitrides, metal oxynitrides, metal carbides, metal oxyborides, Al, Zr, Zn, Sn, Ti, and combinations thereof.

14. The method of claim 10, wherein the applying the bather laminate on the adhesive creates an encapsulated volume between the barrier laminate and the device, the encapsulated volume comprising an edge thickness, and the metal ink having a thickness smaller than the edge thickness of the encapsulated volume.

15. The method of claim 10, wherein the applying the barrier laminate on the adhesive creates an encapsulated volume between the barrier laminate and the device, the encapsulated volume comprising an edge thickness, and the metal strut having a thickness smaller than the edge thickness of the encapsulated volume.

16. A method of making an encapsulated device, the method comprising:
applying an adhesive on the device;
applying a barrier laminate on the adhesive, the barrier laminate comprising one or more dyads, each dyad comprising a barrier layer and a decoupling layer, the barrier layer comprising a barrier material, and the decoupling layer comprising a polymeric or organic material; and
applying an edge sealing member covering an edge portion of the barrier laminate and an edge portion of the adhesive, the edge sealing member comprising a metal material.

17. The method of claim 16, wherein the depositing the edge sealing member comprises attaching a metal ribbon to the edge portion of the barrier laminate and the edge portion of the adhesive.

18. The method of claim 16, wherein the metal material of the edge sealing member comprises a metal selected from the group consisting of aluminum, copper, indium, titanium, barium, magnesium, calcium, sodium, strontium, cesium, zirconium, vanadium, cobalt, iron, alloys thereof, and oxides thereof.

19. The method according to claim 16, wherein the barrier material of the barrier layer is selected from the group consisting of metals, metal oxides, metal nitrides, metal oxynitrides, metal carbides, metal oxyborides, Al, Zr, Zn, Sn, Ti, and combinations thereof.

20. The method of claim 16, wherein the applying the barrier laminate on the adhesive creates an encapsulated volume between the bather laminate and the device, the encapsulated volume comprising an edge thickness, the metal ribbon covering the edge thickness of the encapsulated volume.
